(19) United States
(12) Patent Application Publication
(10) Pub. No.: US 2011/0210666 A1
(43) Pub. Date: Sep. 1, 2011

(54) DRIVING METHOD OF ROAD-ADAPTIVE VEHICLE HEADLIGHT

(75) Inventors: YAOJUNG SHIAO, TAIPEI CITY (TW); CHUN-CHENG CHEN, KAOHSIUNG CITY (TW)

(73) Assignee: NATIONAL TAIPEI UNIVERSITY OF TECHNOLOGY, TAIPEI (TW)

(21) Appl. No.: 12/906,261

(22) Filed: Oct. 18, 2010

(30) Foreign Application Priority Data
Feb. 26, 2010 (TW) 099105690

(51) Int. Cl. B60Q 1/04

(52) U.S. Cl. 315/82

(57) ABSTRACT

In a driving method of a road-adaptive vehicle headlight, after a vehicle is started, the headlight of the vehicle is first adjusted to a basic illumination angle. Then, a vehicle driving environment signal, a vehicle speed signal and vehicle body position signals are obtained. Thereafter, according to the aforesaid different vehicle signals, a power source is controlled to change the illumination angle of the headlight and/or LED light sources provided on a base plate of the headlight are differently controlled to turn on or off. Thus, the vehicle headlight can quickly and flexibly produce different headlight beam patterns and wide headlight beam illumination area to ensure good road visibility and increased safety in driving.

### CROSS-REFERENCE TO RELATED APPLICATION

This non-provisional application claims priority under 35 U.S.C. §119 (a) on Patent Application No (s). 099105690 filed in Taiwan, R.O.C. on 26 Feb., 2010, the entire contents of which are hereby incorporated by reference.

### FIELD OF THE TECHNOLOGY

The present invention relates to a driving method of a road-adaptive vehicle headlight, and more particularly, to a vehicle headlight driving method that enables a vehicle headlight to quickly and flexibly produce different headlight beam patterns and wide headlight beam illumination area to ensure good road visibility and increased safety in driving.

### BACKGROUND

A conventional vehicle headlight, either a motorcycle headlight or a car headlight, can only provide two working modes, namely, a low-beam mode and a high-beam mode. However, in some driving conditions, the conventional headlight fails to provide suitable and sufficient road illumination. Taking a motorcycle headlight as an example, when the motorcycle leans forward or backward due to a shifted center of gravity or bumping along a rough road, or when the motorcycle passes through a curved road, light beams from the motorcycle headlight might not be able to fully project on and illuminate the road to thereby cause danger in riding motorcycle. Therefore, there are increasing demands for an adaptive vehicle headlight, which is also referred to as an advanced vehicle headlight.

According to the currently available adaptive vehicle headlight techniques, a motor is used to drive the headlight to adjust its horizontal, sideward, or angular position. Either a headlight base or a reflection mirror is driven to achieve the positional adjustment of the headlight. However, the currently available vehicle headlight steering techniques have the disadvantages of slow response speed, high manufacturing cost, low flexibility in changing the headlight illumination angle, unable to achieve change of headlight beam patterns, and low design flexibility in headlight appearance.

In recent years, an adaptive vehicle headlight technique using multiple light-emitting diodes (LEDs) as the light sources thereof has been developed. The multiple LED light sources are grouped into several groups and individually controlled to emit or not emit light beams, in order to show different headlight beam patterns.

More specifically, the currently available adaptive vehicle headlight techniques can be divided into two types. One of the two types applies the present LED light technique in the mass production of headlights and uses two or three groups of LED light sources for low beams, high beams and turning, respectively. The other type uses ultrahigh-brightness LED light sources as a design basis, and multiple LED light sources are arrayed at specific positions and angles to separately emit light beams under control according to actual need in different road conditions, so as to show required headlight beam patterns.

While the above-described adaptive vehicle headlight using LED light sources has quick response time, high flexibility in headlight beam patterns and low maintenance cost, it has the disadvantage of non-continuous headlight beam pattern shifting, jumped headlight beam patterns, using a large number of LED light sources, producing a high amount of heat by the LED light sources, and causing discomfort to a rider's eyes.

To overcome the above problems in the conventional vehicle headlight, the inventor has developed improved adaptive headlights separately for motorcycle and car. However, there has not been provided any method for driving an adaptive vehicle headlight. It is therefore tried by the inventor to develop a method of driving the adaptive headlights for motorcycle and car invented by the inventor, so that the headlights on a vehicle can quickly and flexibly produce different headlight beam patterns and wide headlight beam illumination area to ensure good road visibility and increased safety in driving.

### SUMMARY

A primary object of the present invention is to provide a driving method of a road-adaptive vehicle headlight, so that a power source can be controlled to change the illumination angle of the headlight and/or LED light sources provided on a base plate of the headlight can be differently controlled to turn on or off according to different vehicle signals, enabling the vehicle headlight to quickly and flexibly produce different headlight beam patterns and wide headlight beam illumination area to ensure good road visibility and increased safety in driving.

To achieve the above and other objects, the driving method of a road-adaptive vehicle headlight according to the present invention includes the following steps:

(1) obtaining a starting signal of a vehicle and starting the vehicle;

(2) controlling a power source to adjust an illumination angle of at least one headlight of the vehicle;

(3) obtaining a driving environment signal of the vehicle and controlling the at least one LED light source of the at least one headlight of the vehicle to turn on or off according to the driving environment signal;

(4) obtaining a vehicle speed signal of the vehicle and controlling the power source to adjust the illumination angle of the at least one headlight of the vehicle according to the vehicle speed signal; and

(5) obtaining a vehicle body position signal of the vehicle and controlling any one or both of the power source and the at least one LED light source of the at least one headlight according to the vehicle body position signal, so that one of the following actions is taken:

(a) controlling the at least one LED light source of the at least one headlight of the vehicle to turn on or off;

(b) controlling the power source to adjust the illumination angle of the at least one headlight of the vehicle; and

(c) controlling the at least one LED light source of the at least one headlight of the vehicle to turn on or off and controlling the power source to adjust the illumination angle of the at least one headlight of the vehicle; and

(6) repeating the above steps (3) to (5) until a vehicle turn-off signal is obtained, and turning off the vehicle.

With the above adaptive vehicle headlight driving method, the power source can be controlled to change the illumination angle of the headlight and/or the LED light sources can be controlled to turn on or off according to different vehicle signals, so that the vehicle headlight can quickly and flexibly produce different headlight beam patterns and wide headlight beam illumination area to ensure good road visibility and increased safety in driving.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is a system configuration diagram of a vehicle having a headlight controllable with an adaptive vehicle headlight driving method according to a preferred embodiment of the present invention;

FIG. 2 is a structural view of the vehicle headlight of FIG. 1 controllable with the driving method of the present invention;

FIG. 3 is a front view of a base plate for the vehicle headlight of FIG. 2;

FIG. 4 is a flowchart showing the steps included in the method according to the present invention for driving an adaptive vehicle headlight;

FIG. 5 shows an example in which LED light sources of the vehicle headlight are turned on or off in a basic control mode of the driving method of the present invention;

FIG. 6 shows an example in which LED light sources of the vehicle headlight are turned on or off in a road-crossing control mode of the driving method of the present invention;

FIG. 7 shows an example in which LED light sources of the vehicle headlight are turned on or off in a right-turn-at-crossing control mode of the driving method of the present invention;

FIG. 8 shows an example in which LED light sources of the vehicle headlight are turned on or off in a high-speed control mode of the driving method of the present invention;

FIGS. 9 and 10 show two examples in which LED light sources of the vehicle headlight are turned on or off in a left-curved-road control mode of the driving method of the present invention; and

FIGS. 11 to 14 show some examples in which LED light sources of the vehicle headlight are turned on or off in a leveling control mode of the driving method of the present invention.

### DETAILED DESCRIPTION

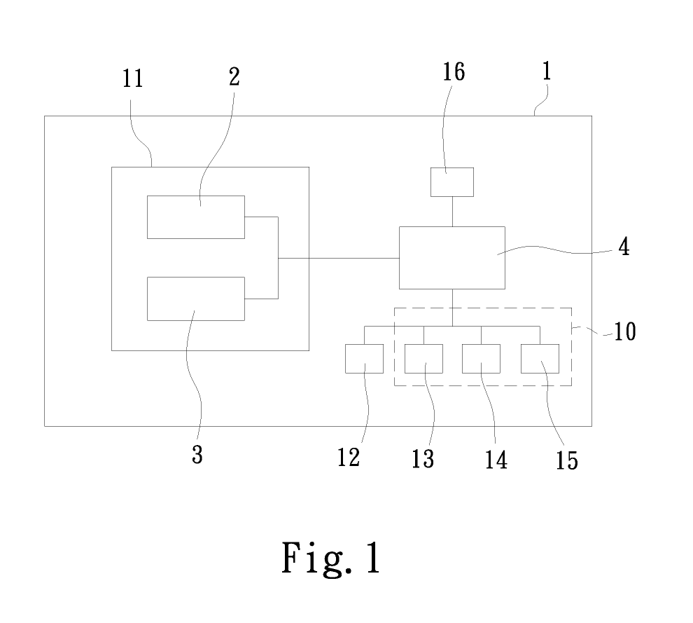

Please refer to FIG. 1 that is a system configuration diagram of a vehicle 1 having a headlight 11 controllable with an adaptive vehicle headlight driving method according to a preferred embodiment of the present invention. As shown, the vehicle 1 has a headlight 11. The headlight 11 includes a power source 2, which can be at least one motor in the illustrated embodiment, and a plurality of LED light sources 3, which can be high-brightness LED light sources in the illustrated embodiment. And, a controller 4 is electrically connected to the power source 2 and the plurality of LED light sources 3. In the illustrated embodiment, the vehicle 1 is a motorcycle having one headlight. However, it is understood the vehicle 1 can be otherwise a car having two headlights. In the latter case, the two headlights are controlled with the same driving method of the present invention.

Moreover, the vehicle 1 is provided with a speed sensor 12 and an angular velocity sensor module 10. The angular velocity sensor module 10 includes a pitch angular velocity sensor 13, a yaw angular velocity sensor 14, and a roll angular velocity sensor 15. The sensors 12, 13, 14, 15 are electrically connected to the controller 4. The controller 4 is also electrically connected to an input setting 16.

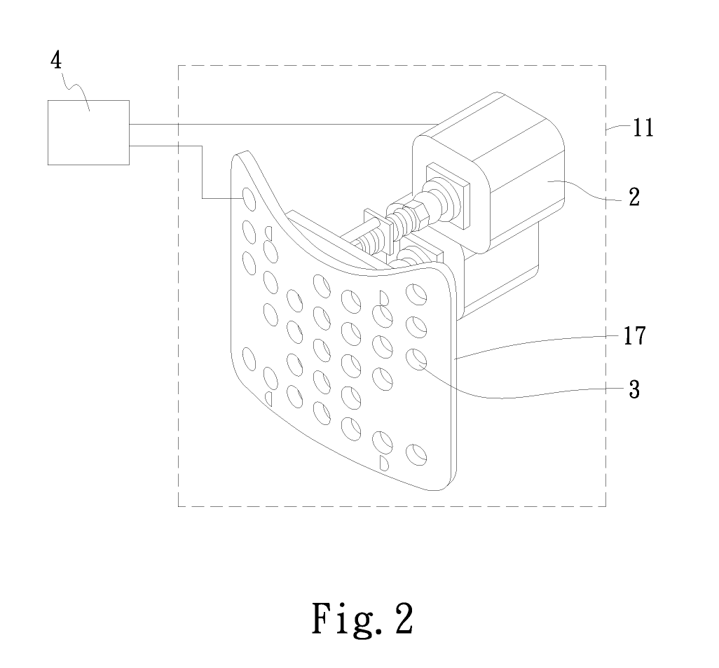

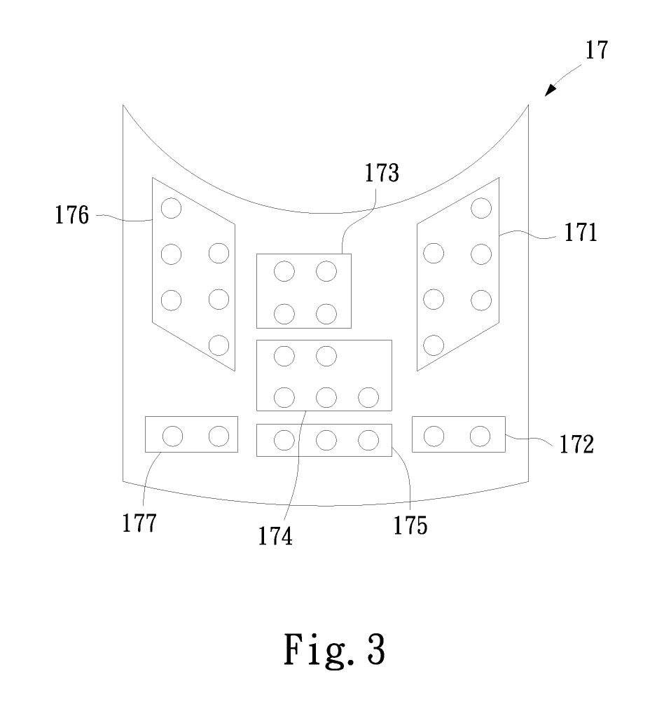

FIG. 2 is a structural view of the vehicle headlight 11 of FIG. 1 controllable with the adaptive vehicle headlight driving method of the present invention, and FIG. 3 is a front view of a base plate 17 for the vehicle headlight 11 of FIG. 2. Please refer to FIGS. 1, 2 and 3 at the same time. As shown, the headlight 11 includes a curved base plate 17, to which the power source 2 is connected. The base plate 17 is generally divided into several lighting zones, including a left-banking lighting zone 171, a left-crossing lighting zone 172, a high-speed lighting zone 173, a main lighting zone 174, a horizontal lighting zone 175, a right-banking lighting zone 176, and a right-crossing lighting zone 177. The plurality of LED light sources 3 are separately mounted within different lighting zones of the base plate 17. The controller 4 controls the power source 2 to drive the base plate 17 to turn, and controls the LED light sources 3 to turn on or off, so that the headlight 11 of the vehicle 1 can produce different illumination angles and light beam patterns. The above vehicle headlight structure has already been described in details in another two U.S. patent applications of the same inventor filed at the same time as the present application, under the title “Road-Adaptive Headlight for Motorcycles” and “Road-Adaptive Vehicle Headlight System”, respectively.

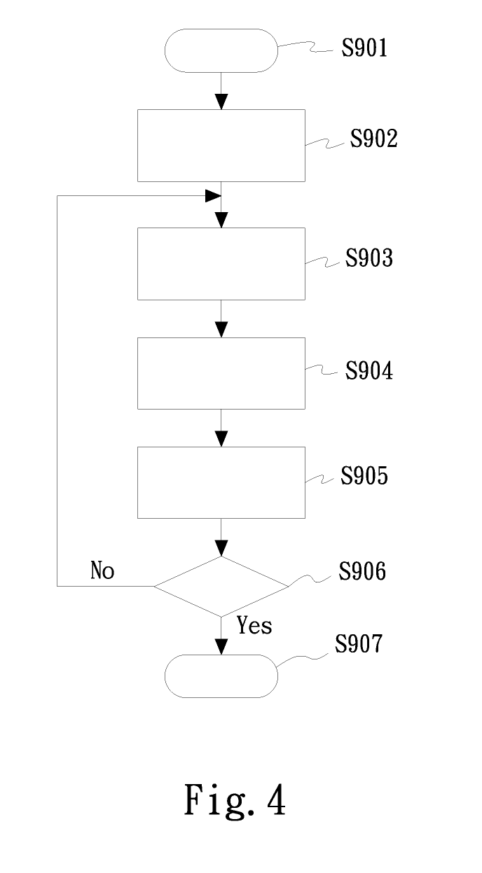

FIG. 4 is a flowchart showing the steps included in a driving method of a road-adaptive vehicle headlight according to a preferred embodiment of the present invention. Please refer to FIGS. 1, 2, 3 and 4 at the same time. According to the driving method of the present invention, first, a starting signal of a vehicle 1 is obtained, and the vehicle 1 is started, accordingly (step S901). Then, a controller 4 controls a power source 2 to adjust and change an illumination angle of a headlight 11 of the vehicle 1 (step S902). In the illustrated preferred embodiment, the controller 4 controls the power source 2 to adjust a horizontal illumination angle of the vehicle headlight 11.

In other words, when the vehicle 1 is started and a center of gravity of the vehicle body shifts to lean the vehicle 1 forward or backward due to the weight of passengers or cargos in the vehicle, it is necessary to adjust the horizontal illumination angle of the headlight 11 of the vehicle 1. Here, by adjusting the horizontal illumination angle, it means to adjust the light beams from the headlight 11 to a standard basic angle, which will also be used as a reference angle in subsequent adjustments of the illumination angle. In this horizontal illumination angle adjustment, since it is necessary to keep the turned-on LED light sources 3 mainly in the main lighting zone 174 and since the horizontal angular change is small and the light beams from the headlight 11 can be adjusted slowly, only the power source 2 is controlled to make the adjustment.

Then, the controller 4 can control the illumination angle of the headlight 11 of the vehicle 1 as well as the on/off of the LED light sources 3 according to different vehicle signals. In other words, the controller 4 obtains a vehicle driving environment signal via the input setting 16. By driving environment, it can mean a city road, a freeway, a curved road, a road crossing, a watery road or the like. The controller 4 can know the driving environment is a city road, a freeway, a curved road, or a road crossing via a global positioning system (GPS); or recognize a curved road or a road crossing from the turning of a steering wheel of the vehicle 1; or know the above-mentioned different driving environments via a manual input. The driving environment is converted into the vehicle driving environment signal via the GPS, the turning of the steering wheel or the manual input. According to the vehicle driving environment signal, the controller 4 controls different LED light sources 3 of the headlight 11 of the vehicle 1 to turn on or off (step S903). Further, a vehicle speed signal indicating the speed of the vehicle 1 can be obtained via the speed sensor 12. According to the vehicle speed signal, the controller 4 controls the power source 2 to adjust the illumination angle of the vehicle headlight 11, such as a horizontal illumination angle thereof (step S904). A vehicle body position signal indicating the position of the vehicle 1 can be obtained via the pitch angular velocity sensor 13, the yaw angular velocity sensor 14 and the roll angular velocity sensor 15. Based on the vehicle body position signals, the controller 4 controls any one or both of the power source 2 and the LED light sources 3 in order to take one of the following actions: (1) controlling the LED light sources 3 of the vehicle headlight 11 to turn on or turn off; (2) controlling the power source 2 to adjust the illumination angle of the vehicle headlight 11; and (3) controlling the LED light sources 3 of the vehicle headlight 11 to turn on or turn off as well as controlling the power source 2 to adjust the illumination angle of the vehicle headlight 11 (step S905).

More specifically, in the above step S903 for controlling the on/off of the LED light sources 3 according to the vehicle driving environment signal, when driving the vehicle 1 in different driving environments, such as driving on a city road, a freeway or a curved road, or passing through a road crossing or a watery road surface, the LED light sources 3 within different lighting zones on the base plate 17 of the headlight 11 would be turned on or off to produce different light beam patterns and accordingly, provide a driver with suitable road illumination. Since the adjustment to be made in the step S903 belongs to the adjustment of light beam patterns, it is achieved by turning on or off of the LED light sources 3 within different lighting zones.

It is understood the horizontal illumination angle of the vehicle headlight 11 has relation with the vehicle speed. For example, light beams from the vehicle headlight 11 must be projected on a relative distant road surface in front of the vehicle 1 when driving on a straight road at high speed, so as to give the driver sufficient response time. Therefore, in the above step S904 for controlling the illumination angle of the headlight 11 according to the vehicle speed signal, when the vehicle speed is higher than a certain speed range, the illumination angle must be adjusted by rising the leveling of the vehicle headlight 11. Since the degree by which the leveling of the head light 11 is to be raised is a function of the vehicle speed, and since the change in the illumination angle is small and the light beams from the headlight 11 can be adjusted slowly, only the power source 2 is controlled to make the adjustment.

It is understood the vehicle 1 would have changes in its pitch angle or roll angle during driving, and such changes occur very quickly. Therefore, in the step S905, the adjustment of the light beams from the headlight 11 according to the vehicle body position during driving is achieved by controlling the on/off of the LED light sources 3 and/or the power source 2. In other words, when the light beams from the vehicle headlight 11 require only a relatively small change in the illumination angle thereof, such small change in the illumination angle can be achieved simply by controlling the on/off of the LED light sources 3 within different lighting zones. On the other hand, when the light beams from the vehicle headlight 11 require a relatively large change in the illumination angle thereof but such angular change can be made slowly, the light beam illumination angle can be adjusted simply by controlling the power source 2 to turn the base plate 17. Or, when the light beams from the vehicle headlight 11 require a relatively large change in the illumination angle thereof and such angular change must be made quickly, the light beam illumination angle can be adjusted by coordinately controlling the on/off of the LED light sources 3 within different lighting zones as well as controlling the power source 2 to turn the base plate 17. In the case both the LED light sources 3 and the power source 2 are controlled to make necessary adjustment of the illumination angle of the headlight 11, first control the LED light sources 3 to change their on/off state to a largest possible extent thereof, and then control the power source 2 to synchronously turn the headlight 11 of the vehicle 1. When the headlight 11 of the vehicle 1 is almost turned to a required angular position, the on/off of the LED light sources 3 is controlled to change again and return to their original on/off state in different lighting zones, so that the LED light sources 3 are prepared to effectively respond to a next required quick adjustment of the illumination angle of the headlight 11 of the vehicle 1.

It is to be noted that the step S903 for controlling the on/off of the LED light sources 3 according to the vehicle driving environment signal, the step S904 for controlling the illumination angle of the headlight 11 according to the vehicle speed signal, and the step S905 for controlling the on/off of the LED light sources 3 and/or the illumination angle of the light beams from the headlight 11 according to the vehicle position signal are not necessarily executed in the above described sequence. For instance, it is possible the steps S903, S904 and S905 occur concurrently; or alternatively, it is possible the step S905 is executed before the steps S903 and S904. In addition, the aforesaid steps S903, S904 and S905 are repeatedly executed, and it is determined whether there is a vehicle turn off signal (step S906). If yes, the vehicle 1 is turned off (step S907).

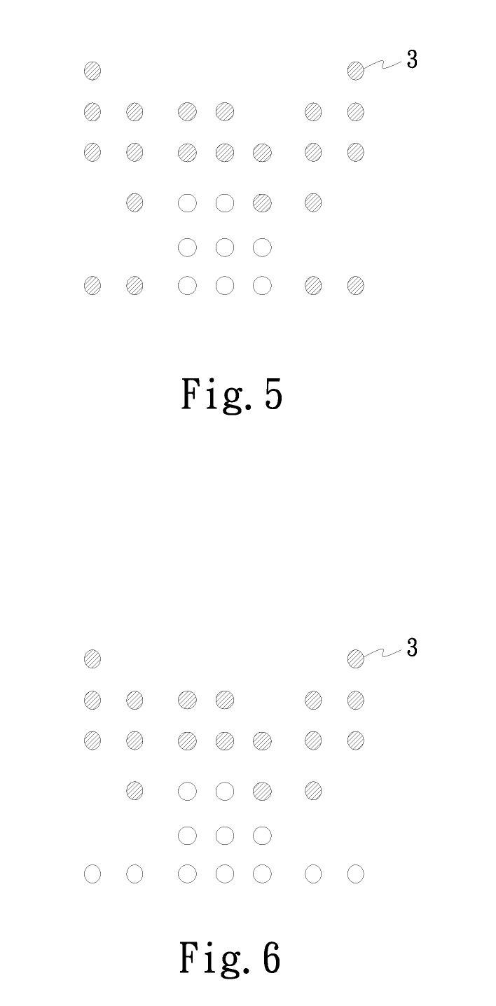

Some adjustment examples based on the above steps S903 to S905 are explained below with reference to FIGS. 5 to 14. As can be seen from FIGS. 5 to 14, the on/off of the LED light sources 3 within different lighting zones is different in each of the illustrated examples.

Please refer to the example shown in FIG. 5, which shows a basic control mode according to the vehicle headlight driving method of the present invention, in which only the on/off of different LED light sources 3 is changed under control.

Please refer to the example shown in FIG. 6, which shows a road-crossing control mode according to the vehicle headlight driving method of the present invention. Basically, in this mode, only the change in the on/off of different LED light sources 3 under control would suffice. However, in the case of bumping along a rough road, the control of the headlight according to the vehicle body position signal would also be executed.

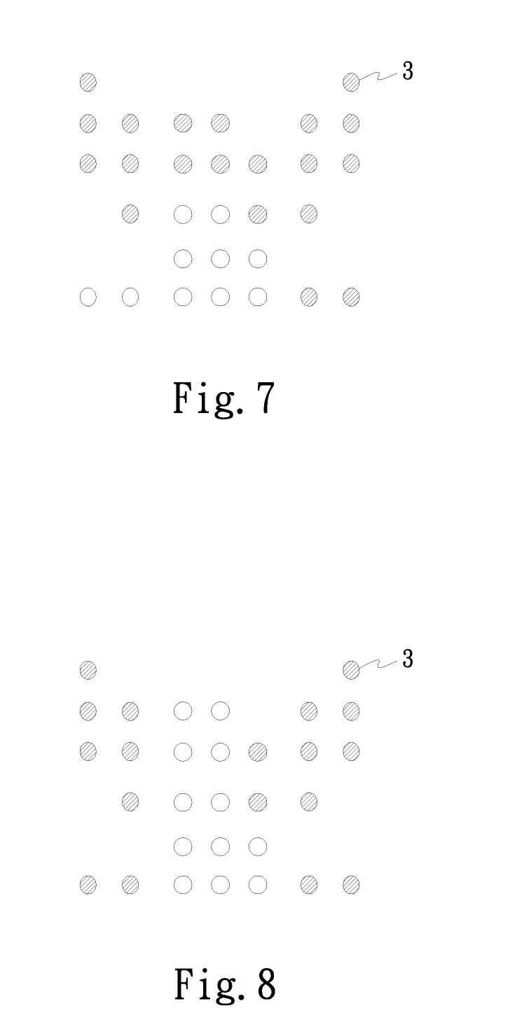

Please refer to the example shown in FIG. 7, which shows a right-turn-at-crossing control mode according to the vehicle headlight driving method of the present invention. Basically, in this mode, only the change in the on/off of different LED light sources 3 under control would suffice. However, in the case of bumping along a rough road, the control of the headlight according to the vehicle body position signal would also be executed.

Please refer to the example shown in FIG. 8, which shows a high-speed control mode according to the vehicle headlight driving method of the present invention. Basically, in this mode, only the change in the on/off of different LED light sources 3 under control would suffice. However, in the case of bumping along a rough road, the control of the headlight according to the vehicle body position signal would also be executed.

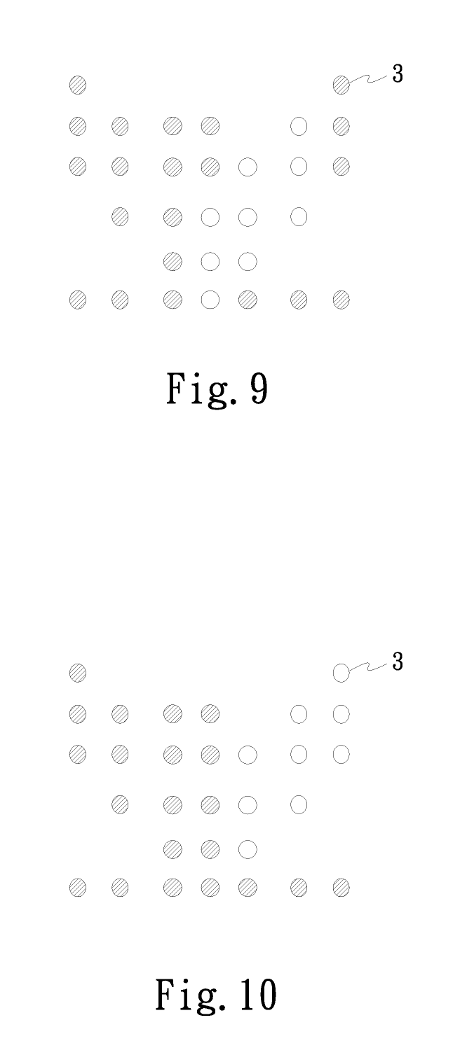

Please refer to FIGS. 1, 9 and 10 at the same time. The examples illustrated in FIGS. 9 and 10 show a left-curved-road control mode according to the vehicle headlight driving method of the present invention. Basically, in the case of driving the vehicle on a curved road having a relatively small curve angle, only the change in the on/off of different LED light sources 3 under control would suffice, as shown in FIG. 9. However, in the case of driving the vehicle on a curved road having a relatively large curve angle, the power source 2 would be driven to adjust the illumination angle of the vehicle headlight 11; or the on/off of the LED light sources 3 is changed under control and the power source 2 is also controlled to adjust the illumination angle at the same time, as shown in FIG. 10, in the case quick change in the on/off of the LED light sources and the illumination angle is required. It is to be noted that the on/off of the LED light sources 3 shown in FIGS. 9 and 10 is based on a left-curved-road control mode. In the case of driving on a right-curved road, the on/off states of the LED light sources 3 under control are laterally reversed mirror images of FIGS. 9 and 10.

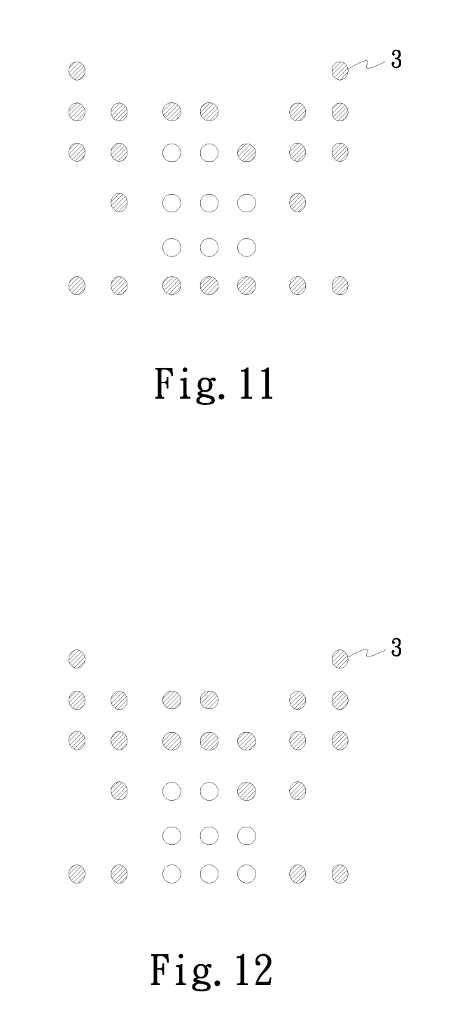

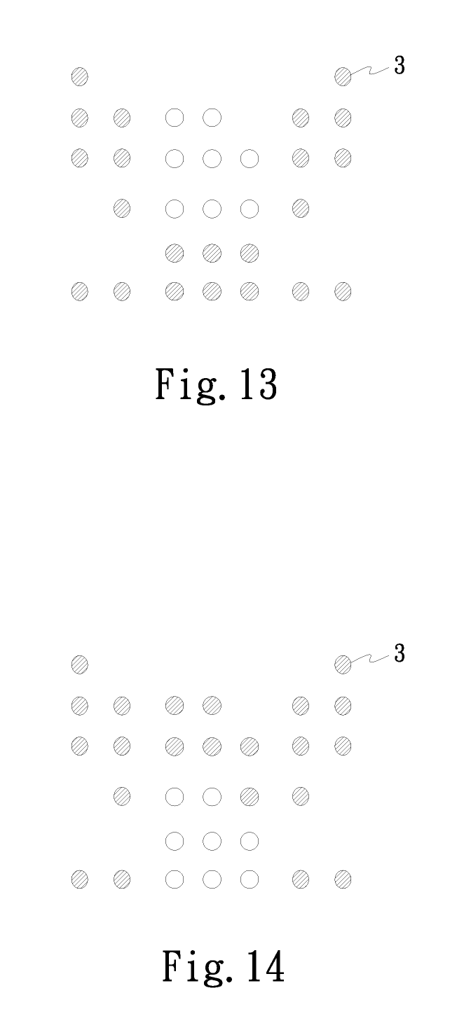

Please refer to FIGS. 1 and 11 to 14 at the same time. The examples illustrated in FIGS. 11 to 14 show a leveling control mode according to the vehicle headlight driving method of the present invention. The example shown in FIG. 11 indicates that, in the case the light beam is adjusted upward by a relatively small angle, either the power source 2 is controlled to change the illumination angle or the on/off of the LED light sources 3 is changed, depending on the required change speed. The example shown in FIG. 12 indicates that, in the case the light beam is adjusted downward by a relatively small angle, either the power source 2 is controlled to change the illumination angle or the on/off of the LED light sources 3 is changed, depending on the required change speed. The example shown in FIG. 13 indicates that, in the case the light beam is adjusted upward by a relatively large angle, the headlight 11 is adjusted via the power source 2, or the LED light sources 3, or both of the power source 2 and the LED light sources 3, depending on the required change speed. The example shown in FIG. 14 indicates that, in the case the light beam is adjusted downward by a relatively large angle, the headlight 11 is adjusted via the power source 2, or the LED light sources 3, or both of the power source 2 and the LED light sources 3, depending on the required change speed.

The following table lists the above-mentioned control manners in different change angles and change speeds:

| | Change angle | | | |
|---|---|---|---|---|
| | | Small | Moderate | Large |
| Change | Quick | LED | LED + Power | LED + Power |
| speed | | | source | source |
| | Moderate | LED | LED | LED + Power |
| | | | | source |
| | Slow | Power source | Power source | Power source |

Thus, with the above described driving method, one or both of the power source 2 and the LED light sources 3 can controlled for the headlight 11 of the vehicle 1 to produce different light beam patterns and light beam illumination angles. That is, the vehicle headlight driving method of the present invention controls the power source 2 to change the illumination angle of the headlight 11 and/or controls the LED light sources 3 to turn on or off according to different vehicle signals, such as the vehicle driving environment signal, the vehicle speed signal, and the vehicle body position signal, so that the headlight 11 of the vehicle 1 can quickly and flexibly produce different headlight beam patterns and wide headlight beam illumination area to ensure good road visibility and increased safety in driving.

Accordingly, the driving method of a road-adaptive vehicle headlight according to the present invention is novel, improved, and industrially practical for use. The present invention is novel and improved because it controls the illumination angle of the headlight and/or the on/off of the LED light sources according to different vehicle signals, so that the vehicle headlight can quickly and flexibly produce different headlight beam patterns and wide headlight beam illumination area to ensure good road visibility and increased safety in driving. It is trusted products derived from the present invention would fully satisfy the current market demands for dynamically controlling the vehicle headlight.

The present invention has been described with a preferred embodiment thereof and it is understood many changes and modifications in the described embodiment can be carried out without departing from the scope and the spirit of the invention that is intended to be limited only by the appended claims.

What is claimed is:

1. A driving method of a road-adaptive vehicle headlight, comprising the steps of:
(1) obtaining a starting signal of a vehicle and starting the vehicle;
(2) controlling a power source to adjust an illumination angle of at least one headlight of the vehicle;
(3) obtaining a vehicle driving environment signal of the vehicle and controlling the on/off of at least one LED light source of the at least one headlight of the vehicle according to the vehicle driving environment signal;
(4) obtaining a vehicle speed signal of the vehicle and controlling the power source to adjust the illumination angle of the at least one headlight of the vehicle according to the vehicle speed signal; and
(5) obtaining a vehicle body position signal of the vehicle and controlling one of the power source and the at least one LED light source of the at least one headlight according to the vehicle body position signal, so that one of the following actions is taken:
(a) controlling the at least one LED light source of the at least one headlight of the vehicle to turn on or off;
(b) controlling the power source to adjust the illumination angle of the at least one headlight of the vehicle; and
(c) controlling the at least one LED light source of the at least one headlight of the vehicle to turn on or off and controlling the power source to adjust the illumination angle of the at least one headlight of the vehicle; and
(6) repeating the above steps (3) to (5) until a vehicle turn-off signal is obtained, and turning off the vehicle.

2. The driving method as claimed in claim 1, wherein, in the step (2), the illumination angle is a horizontal illumination angle.

3. The driving method as claimed in claim 1, wherein, in the step (3), the vehicle driving environment signal is obtained via an input setting.

4. The driving method as claimed in claim 1, wherein, in the step (4), the vehicle speed signal is obtained via a speed sensor.

5. The driving method as claimed in claim 1, wherein, in the step (4), the illumination angle is a horizontal illumination angle.

6. The driving method as claimed in claim 1, wherein, in the step (5), the vehicle body position signal is obtained via an angular velocity sensor module, and the angular velocity sensor module including a pitch angular velocity sensor, a yaw angular velocity sensor, and a roll angular velocity sensor.

7. The driving method as claimed in claim 1, wherein the power source comprises at least one motor.
